(19) United States
(12) Patent Application Publication
(10) Pub. No.: US 2011/0149733 A1
(43) Pub. Date: Jun. 23, 2011

(54) ROUTER AND LOAD BALANCE METHOD THEREOF

(75) Inventor: JONG-CHANG CHEN, Tu-Cheng (TW)

(73) Assignee: HON HAI PRECISION INDUSTRY CO., LTD., Tu-Cheng (TW)

(21) Appl. No.: 12/730,259

(22) Filed: Mar. 24, 2010

(30) Foreign Application Priority Data
Dec. 18, 2009 (CN) 200910311866.3

(51) Int. Cl. H04L 12/56

(52) U.S. Cl. 370/235; 370/401

(57) ABSTRACT

A router stores a predetermined threshold of a first wide area network (WAN) port transmitting packets and connects to the Internet via the first WAN port. The router detects traffic values of transmitted packets through the first WAN port at different time points and stores the traffic values in the storage system. The router determines whether a current traffic value is equal to a previous traffic value, and determines whether the current traffic value is greater than the predetermined threshold of the first WAN port if the current traffic values are not equal to the previous traffic value. The router switches a connection between the first WAN port and the Internet to a connection between the second WAN port and the Internet if the current traffic value is greater than the predetermined threshold.

### BACKGROUND

1. Technical Field

Embodiments of the present disclosure relate to network communication devices, and more particularly to a router and a load balance method thereof.

2. Description of Related Art

Currently, one solution to resolve network congestion in a router includes the router contacting a termination system, and detecting a path having a low traffic value, which is known as a load of the router. Alternatively, another solution involves the router can simply remaining idle and transmits packets when the network congestion eases.

However, the former solution requires the presence of the termination system, and the latter solution wastes time. Each reduces router efficiency in packet processing. Thus, an additional solution is called for.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of an application environment of an embodiment of a router of the present disclosure;

FIG. 2 is a schematic diagram of functional modules of the router of FIG. 1; and

FIG. 3 is a flowchart of a load balance method of one embodiment of the router of the present disclosure.

### DETAILED DESCRIPTION

All of the processes described may be embodied in, and fully automated via, software code modules executed by one or more general purpose computers or processors. The code modules may be recorded in any type of computer-readable medium or other storage device. Some or all of the methods may alternatively be embodied in specialized computer hardware or communication apparatus.

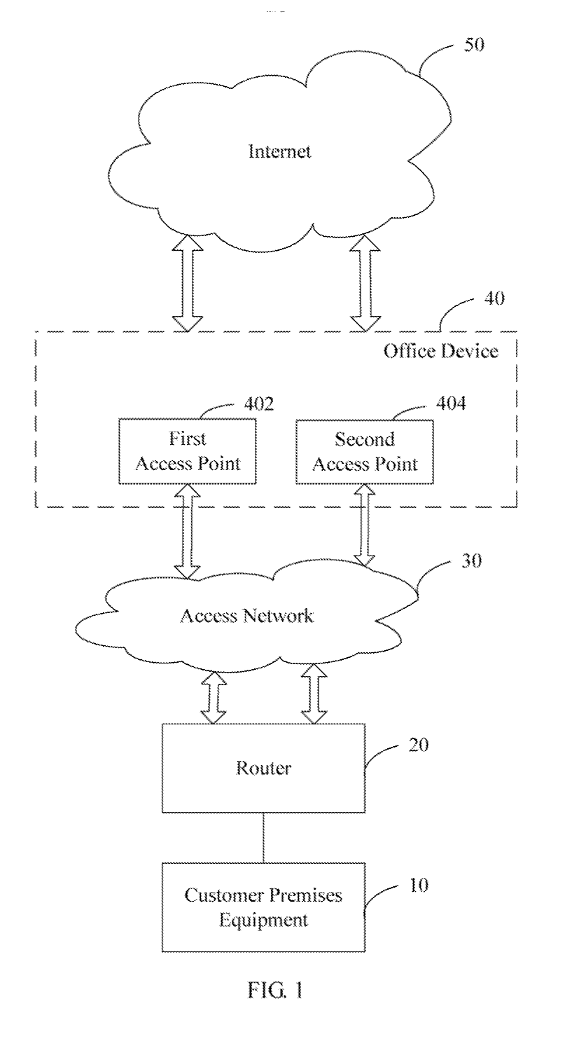

FIG. 1 is a schematic diagram of an application environment of an embodiment of a router 20 of the present disclosure. Customer premises equipment (CPE) 10 connects to an access network 30 via the router 20, and further connects to the Internet 50 via an office device 40. The office device 40 includes a first access point 402 and a second access point 404. The CPE 10 may be a personal computer or a personal digital assistant, for example. The router 20 comprises at least two wide area network (WAN) ports. The at least two WAN ports connect to the first access point 402 and the second access point 404 via the access network 30, respectively. In one embodiment, the first access point 402 and the second access point 404 provide Internet 50 access for the CPE 10. In one embodiment, the first access point 402 and the second access point 404 may be a 3.5 GHz cable modem access point and an asymmetrical digital subscriber loop (ADSL) access point, respectively.

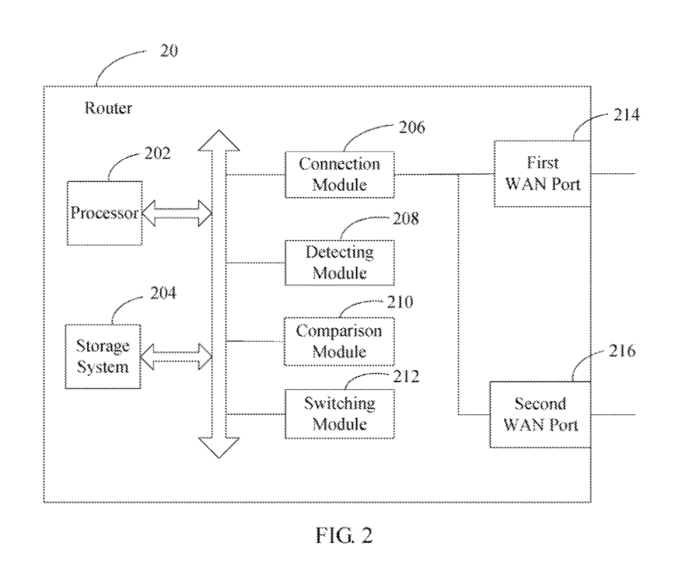

FIG. 2 is a schematic diagram of functional modules of the router 20 of FIG. 1. In one embodiment, the router 20 comprises a processor 202, a storage system 204, a connection module 206, a detecting module 208, a comparison module 210, a switching module 212, a first WAN port 214, and a second WAN port 216. In one embodiment, the router 20 connects to the office device 40 via the first WAN port 214 and the second WAN port 216, and further connects to the Internet 50 via the office device 40.

The connection module 206, the detecting module 208, the comparison module 210, and the switching module 212 can comprise one or more computer-executable instructions that are executed by the processor 202.

The storage system 204 is operable to store a predetermined threshold of transmitted packets by the first WAN port 214. In one embodiment, the predetermined threshold of transmitted packets by the first WAN port 214 is a maximum traffic value of the first WAN port 214.

The connection module 206 is operable to connect to the Internet 50 via the first WAN port 214.

The detecting module 208 is operable to detect traffic values of transmitted packets through the first WAN 214 port at different time points and store the traffic values in the storage system 204. In one embodiment, the traffic values comprise at least a current traffic value and a previous traffic value.

The comparison module 210 is operable to determine whether the current traffic value is equal to the previous traffic value, and determine whether the current traffic value is greater than the predetermined threshold of transmitted packets by the first WAN port 214 if the current traffic value is not equal to the previous traffic value. In one embodiment, the current traffic value is equal to the previous traffic value, which indicates that network congestion may be present in a path between the first WAN port 214 of the router 20 and the Internet 50.

The switching module 212 is operable to switch from a connection between the first WAN port 214 and the Internet 50 to a connection between the second WAN port 216 and the Internet 50 if the current traffic value is greater than the predetermined threshold of the first WAN port 214. In one embodiment, if the current traffic value is greater than the predetermined threshold of transmitted packets by the first WAN port 214, the router 20 will terminate the connection between the first WAN port 214 and the Internet 50, and initiate the connection between the second WAN port 216 and the Internet 50.

In one embodiment, the current traffic value is not equal to the previous traffic value and the current traffic value is equal to or less than the predetermined threshold of the first WAN port 214, which indicates that no network congestion is present in the path between the first WAN port 214 of the router 20 and the Internet 50. In such a case, the detecting module 208 is further operable to continue detecting traffic values of transmitted packets through the first WAN 214 port at different time points and store the traffic values in the storage system 204.

In one embodiment, if the current traffic value is greater than the predetermined threshold of the first WAN port 214, the first WAN port 214 transmitting packets may lose packets. In such a case, the switching module 212 terminates the connection between the first WAN port 214 and the Internet 50, and initiates the connection between the second WAN port 216 and the Internet 50 in order to avoid losing packets.

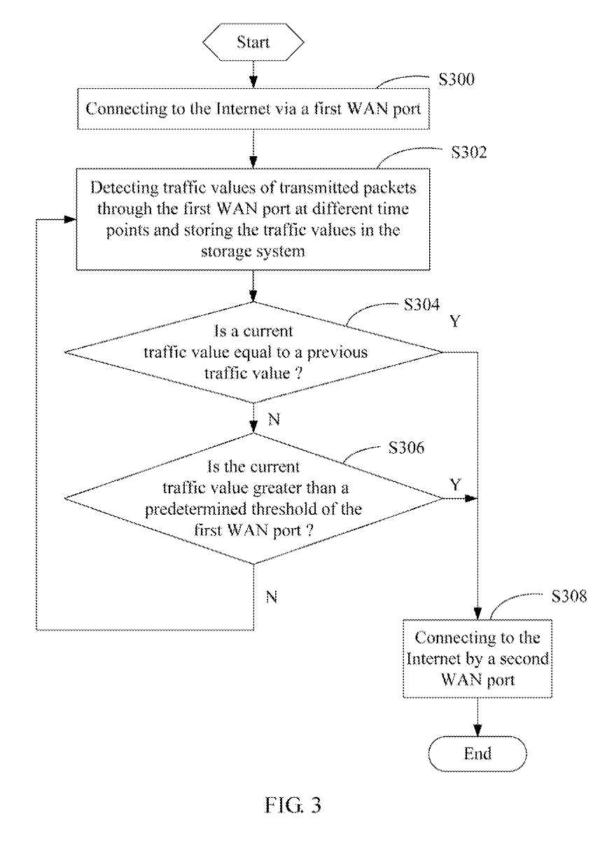

FIG. 3 is a flowchart of a load balance method of one embodiment of the router 20 of the present disclosure. The load balance method is executed via the functional modules of the router 20 in FIG. 2. Depending on the embodiment, additional blocks may be added, others deleted, and the ordering of the blocks may be changed while remaining well within the scope of the disclosure.

In block S300, the connection module 206 connects to the Internet 50 via the first WAN port 214.

In block S302, the detecting module 208 detects traffic values of transmitted packets through the first WAN port 214 at different time points and stores the traffic values in the storage system 204. In one embodiment, the traffic values comprise at least a current traffic value and a previous traffic value.

In block S304, the comparison module 210 determines whether the current traffic value is equal to the previous traffic value.

If not, then in block S306, the comparison module 210 further determines whether the current traffic value is greater than the predetermined threshold of transmitted packets by the first WAN port 214.

If the current traffic value is equal to or less than the predetermined threshold of transmitted packets by the first WAN port 214, block S302 is repeated and the detecting module 208 continues detecting traffic values of transmitted packets through the first WAN 214 port at different time points and stores the traffic values in the storage system 204.

If the current traffic value is equal to the previous traffic value, or the current traffic value is greater than the predetermined threshold of transmitted packets by the first WAN port 214, in block S308, the switching module 212 ends the connection between the first WAN port 214 and the Internet 50, and starts the connection between the second WAN port 216 and the Internet 50.

In one embodiment, the storage system 204 also stores a plurality of traffic values and a predetermined threshold of the second WAN port 216 transmitting packets when the router 20 connects to the Internet 50 via the second WAN port 216. In one embodiment, connection to the Internet 50 via the second WAN port 216 is the same as connection to the Internet 50 via the first WAN port 214 (S300˜S308). By switching between the first WAN port 214 and the second WAN port 216, the router 20 can balance the loads of the first WAN port 214 and the second WAN port 216, and thereby improve efficiency thereof.

In one embodiment, the router 20 determines load of one WAN port by comparing the current traffic value and the previous traffic value of the WAN port, and switches from the WAN port to another WAN port if the WAN port is experiencing network congestion. Thus, the router 20 requires no termination system and improves efficiency greatly in processing packets.

While various embodiments and methods of the present disclosure have been described, it should be understood that they have been presented by example only and not by limitation. Thus the breadth and scope of the present disclosure should not be limited by the above-described embodiments, but should be defined only in accordance with the following claims and their equivalents.

What is claimed is:

1. A router, comprising:
a first wide area network (WAN) port;
a second WAN port;
a storage system operable to store a predetermined threshold of transmitted packets by the first WAN port;
a connection module operable to connect to the Internet via the first WAN port;
a detecting module operable to detect traffic values of transmitted packets through the first WAN port at different time points and store the traffic values in the storage system, wherein the traffic values comprise at least a current traffic value and a previous traffic value;
a comparison module operable to determine whether the current traffic value is equal to the previous traffic value, and determine whether the current traffic value is greater than the predetermined threshold of the first WAN port if the current traffic value is not equal to the previous traffic value;
a switching module operable to switch from a connection between the first WAN port and the Internet to a connection between the second WAN port and the Internet if the current traffic value is greater than the predetermined threshold of the first WAN port; and
a processor operable to execute the storage system, the connection module, the detecting module, the comparison module, and the switching module.

2. The router as claimed in claim 1, wherein the switching module is further operable to switch from the connection between the first WAN port and the Internet to the connection between the second WAN port and the Internet if the current traffic value is equal to the previous traffic value.

3. The router as claimed in claim 2, wherein the storage system is further operable to store a predetermined threshold of the second WAN port transmitting packets.

4. The router as claimed in claim 1, wherein the detecting module is further operable to continue detecting traffic values of transmitted packets through the first WAN port at different time points and store the traffic values in the storage system if the current traffic value is equal to or less than the predetermined threshold of the first WAN port transmitting packets.

5. A load balance method for a router, the router comprising a first wide area network (WAN) port, a second WAN port, and a storage system, wherein the storage system stores a predetermined threshold of transmitted packets by the first WAN port, the load balance method comprising:
connecting to the Internet via the first WAN port;
detecting traffic values of transmitted packets through the first WAN port at different time points and storing the traffic values in the storage system, wherein the traffic values comprise at least a current traffic value and a previous traffic value;
determining whether the current traffic value is equal to the previous traffic value;
determining whether the current traffic value is greater than the predetermined threshold of the first WAN port if the current traffic value is not equal to the previous traffic value; and
switching from a connection between the first WAN port and the Internet to a connection between the second WAN port and the Internet if the current traffic value is greater than the predetermined threshold of the first WAN port.

6. The load balance method as claimed in claim 5, further comprising switching from the connection between the first WAN port and the Internet to the connection between the second WAN port and the Internet if the current traffic value is equal to the previous traffic value.

7. The load balance method as claimed in claim 6, wherein the storage system is further operable to store a predetermined threshold of the second WAN port transmitting packets.

8. The load balance method as claimed in claim 5, further comprising continuing detecting traffic values of transmitted packets through the first WAN port at different time points and store the traffic values in the storage system if the current traffic value is equal to or less than the predetermined threshold of the first WAN port transmitting packets.
